(19) United States
(12) Patent Application Publication
(10) Pub. No.: US 2023/0002626 A1
(43) Pub. Date: Jan. 5, 2023

(54) COATING COMPOSITIONS AND METHODS OF USE

(71) Applicant: CAL-TEX PROTECTIVE COATINGS, INCORPORATED, Schertz, TX (US)

(72) Inventors: Tomasz Klukowski, New Braunfels, TX (US); Thomas Engelken, Schertz, TX (US); Eloy Flores, Live Oak, TX (US)

(21) Appl. No.: 17/856,882

(22) Filed: Jul. 1, 2022

Related U.S. Application Data
(60) Provisional application No. 63/217,694, filed on Jul. 1, 2021.

(51) Int. Cl. C09D 7/61; C09D 183/04

(52) U.S. Cl. CPC C09D 7/61; C09D 183/04

(57) ABSTRACT

A composition for coating a surface is disclosed. The composition may include: water; a carbon allotrope having some carbon atoms having less bonds than quaternary carbon atoms; a ceramic compound; a wax; and a protonated compound. A method of forming a coating composition can include combining water, an organosilicon composition, a silicone quaternary compound, and an acid to form a first solution, providing a second solution comprising a carbon allotrope having some carbon atoms with less bonds than quaternary carbon atoms in an aqueous fluid, forming a third solution comprising a wax and a ceramic compound, mixing the first solution with the second solution to form a fourth solution, and mixing the third solution with the fourth solution to form the coating composition

### CROSS-REFERENCE TO RELATED APPLICATIONS

This application claims priority to U.S. Provisional Patent Application No. 63/217,694 filed on Jul. 1, 2021, and entitled “Coating Compositions and Methods of Use,” which is incorporated herein in its entirety by reference.

### BACKGROUND

Various surfaces such as painted surfaces and the like can be coated in order to protect the underlying surface over time. Improvements in the resulting coating can improve the protection of the surface. While various types of coatings can be applied, ease of application is often taken into account in selecting the coating used. For example, the coating process must be compatible with the surface being coated (e.g., taking temperature, processing steps, etc. into account) as well as the amount of labor involved in applying the coating.

### SUMMARY

In some embodiments, a composition for coating a surface comprises an aqueous solution, a carbon allotrope having some carbon atoms having less bonds than quaternary carbon atoms, a ceramic compound, a wax, and a protonated compound.

In some embodiments, a method of forming a coating composition comprises combining water, an organo silicon composition, a silicone quaternary compound, and an acid to form a first solution, providing a second solution comprising a carbon allotrope having some carbon atoms with less bonds than quaternary carbon atoms in an aqueous fluid, forming a third solution comprising a wax and a ceramic compound, mixing the first solution with the second solution to form a fourth solution, and mixing the third solution with the fourth solution to form the coating composition.

In some embodiments, a coating layer disposed on a surface comprises a wax, a tertiary carbon allotrope, and a ceramic compound. The tertiary carbon allotrope and the ceramic compound are disposed within the wax as a layer on the surface.

These and other features will be more clearly understood from the following detailed description taken in conjunction with the accompanying drawings and claims.

### DETAILED DESCRIPTION

Disclosed herein are improved coating compositions for various surfaces, methods of forming the coating compositions, methods of applying the coating compositions, and surfaces having the resulting coatings disposed thereon. The coatings can comprise a number of ingredients to form the coating such as a wax or other hydrocarbon to form a protective barrier. A ceramic compound can be included to increase hardness and wear resistance. In some aspects, carbon compounds such as a carbon allotrope (e.g., graphene, etc.) can be included to improve performance of the coating.

The coatings can be applied to various surface such as painted surfaces, metallic surfaces, plastic surfaces, or most other surfaces subject to environmental conditions such as items placed outdoors. In some aspects, the coating can be applied to one or more surfaces associated with vehicles. For example, the coatings can be applied to various painted surfaces, plastic surfaces, or the like on a motor vehicle. Various motor vehicles can include, but are not limited to, passenger automobiles, sports utility vehicles (SUV), buses, trucks, various commercial vehicles, watercraft including a variety of boats and ships, aircraft, and the like. The coatings may also be provided as consumer products if, e.g., diluted by half, to lower volatile organic compound (VOC) levels below environmental regulatory standards.

The coating composition disclosed herein comprises an aqueous solution of various elements that allow the components to remain in solution in a stable formulation. The term “solution” as used herein may include a liquid colloidal solution having a uniform dispersion of colloidal particles as well as, in some instances, a suspension such as a dispersion, e.g., solid in liquid. In some aspects, the particles can have a size of about 1 to about 100 nanometers (nm). The coating composition can then be used to form one or more coatings as described herein. In some aspects, the coating composition comprises: an aqueous solution, the carbon allotrope, a ceramic compound, a wax, and a protonated compound. The resulting solution can be described as a slurry or emulsion having the components dispersed within the aqueous phase.

The aqueous solution can form the base of the solution. In some aspects, the aqueous solution can comprise water from any suitable source such as reverse osmosis, distilled, deionized, or other form of substantially pure water. In some aspects, the water can comprise some amount of dissolved components without affecting the stability, use, or finish of the coating.

The carbon allotrope may be present in a number of forms. Generally, the carbon allotrope has some carbon atoms with less bonds than quaternary carbon atoms and a hardness on the Mohs hardness scale as determined by the Mohs hardness test of less than about 9, less than about 8, and even less than about 5. Typically, the carbon allotrope is a primary, a secondary, and/or a tertiary carbon. In some exemplary embodiments, the carbon allotrope is a tertiary carbon, such as a graphene, a graphite, and a nanotube. The graphene can be present in a number of forms. In general, the graphene forms a sheet-like layer on an atomic scale. The carbon atoms may be arranged in a honeycomb shaped lattice. The graphene can be present in the coating composition as a pure graphene (e.g., pure carbon-based graphene) and/or as a functionalized graphene. For example, the graphene can comprise a graphene oxide, a reduced graphene oxide, or the like. The use of the various forms of the graphene can contribute to the stability of the graphene in solution. The carbon allotrope, such as the graphene, may improve the durability of the final coating.

The ceramic compound can also be present to improve the durability of the final coating. Any suitable ceramic component can be used in the coating composition. In some aspects, the ceramic component can be a silicon oxide, such as silicon dioxide or silicon monoxide, although in other aspects the ceramic component can comprise one or more of oxides, phosphates, fluorides, nitrides, carbides, disilicides, and zeolites with at least one metallic and nonmetallic elements, such as: silicon oxide (SiO₂), aluminum oxide (Al₂O₃), lithium titanium oxide (Li₄Ti₅O₁₂), titanium oxide (TiO₂), tin oxide (SnO₂), cerium oxide (CeO₂), zirconium dioxide (ZrO₂), vanadium oxide (V₂O₅), boron oxide (B₂O₃), barium titanium oxide (BaTiO₃), yttrium oxide (Y₂O₃), tungsten trioxide (WO₃), magnesium oxide (MgO), copper oxide (CuO), zinc oxide (ZnO), aluminum phosphate (AlPO₄), aluminum fluorine (AlF), silicon nitride (Si₃N₄), aluminum nitride (AlN), titanium nitride (TiN), tungsten carbide (WC), silicon carbide (SiC), titanium carbide (TiC), molybdenum disilicide (MoSi₂), iron oxide (Fe₂O₃), germanium dioxide (GeO₂), lithium oxide (Li₂O), manganese oxide (MnO), nickel oxide (NiO), zeolite, or any combination thereof. The ceramic compound may be present as particles having a size in a range of about 0.01 micron (μm) to about 100 μm.

The coating composition can also include a wax. A wax is typically a low-melting organic mixture or compound of high molecular weight, solid at room temperature and generally similar in composition to fats and oils except that it contains no glycerides. The wax can comprise any suitable vehicular wax capable of bonding with a surface. In general, the wax can comprise a hydrocarbon of between about 20-40 carbon atoms and be in various forms such as acids, fatty alcohols, esters, straight chained or branched hydrocarbons (alkanes or paraffins, such as normal paraffins or isoparaffins). Fatty alcohols (or long-chain alcohols) are usually high-molecular-weight, straight-chain primary alcohols, but can also range from as few as 4-6 carbons to as many as 22-26, derived from natural fats and oils. Some commercially available fatty alcohols are lauryl, stearyl, and oleyl alcohols.

In some aspects, the wax can include a natural wax, such as an animal wax, e.g., a lanolin or a shellac wax, or a vegetable wax. One exemplary vegetable wax is a carnauba wax, though other waxes can be used in place of carnauba wax or in combination with carnauba wax.

The coating composition can also comprise a protonated compound. In some aspects, any compound capable of being protonated to form a charged compound can be used with the coating composition. As disclosed herein, the protonated compound can comprise an organosilicone compound such as a siloxane. The organosilicone can be protonated by a reaction with one or more components such as an acid. The organosilicone compound can aid in blocking ultraviolet radiation.

Any suitable acids can be used to form the protonated compound such as mineral acids, organic acids, such as hydroxyacetic acid, and the like. In some aspects, the protonated compound can comprise a siloxane such as a polydimethylsiloxane. The protonated compound can impart a positive or cationic charge to the coating composition. This positive charge aids application when applied to a negatively charged object, such as a vehicle.

In some aspects, the coating composition can also comprise a hydrophobic component such as a silicone quaternary compound. The hydrophobic component can help to form a hydrophobic final coating on the surface.

Any number of suitable additives can also be included in the coating composition. Suitable examples can include, one or more organic solvents, a mineral oil, an emulsifier, a surfactant, a thickener, a pH adjusting agent, or any combination thereof.

Any suitable amounts of the components can be used with the coating compositions. In some aspects, the various components can have the following ranges: an aqueous solution between about 50 weight percent (wt. %) and about 95 wt. % of the composition; a graphene between about 0.001 wt. % and about 3 wt. % of the composition; a ceramic compound between about 0.1 wt. % and about 3 wt. % of the composition; a wax between about 1 wt. % and about 15 wt. % of the composition; and a protonated compound between about 1 wt. % and about 20 wt. % of the composition.

The resulting composition can form a stable suspension over time. More specially, the resulting composition may not experience the various components including the graphene, ceramic, wax, and protonated compound separating within the suspension such that the composition cannot be evenly applied to a surface. In other word, the composition may form a uniformly dispersed suspension or solution and be stable for several weeks, months, or even years.

Various ingredients in the coating composition can interact to cause one or more components to precipitate, agglomerate, or otherwise separate from the mixture. In order to prevent these interactions, the elements are processes as separate solutions or mixtures prior to being combined. In some aspects, a method of forming a coating composition can include: combining water, an organosilicon composition, a silicone quaternary compound, and an acid to form a first solution, providing a second solution comprising graphene in an aqueous fluid, and forming a third solution comprising a wax and a ceramic compound. The first solution can then be mixed with the second solution to form a fourth solution, and the third solution can be mixed with the fourth solution to form the coating composition.

Generally, the weight ratio of the first solution to the second solution is 4:1 to 1:2, or 3:1 to 1:1. The weight ratio of the first solution to the third solution can be 8:1 to 1:1, or 8:1 to 2:1. The weight ratio of the second solution to the third solution can be 5:1 to 1:2, or 4:1 to 1:1. The weight ratio of the fourth solution to the third solution can be 15:1 to 2:1, or 10:1 to 6:1.

As a result, there are three separate mixtures used within the coating composition formation process. Initially, the aqueous solution, the organosilicon composition, a silicone quaternary compound, and a protonation agent such as an acid are combined to form a first mixture. The organosilicon composition can be protonated by the acid in the resulting suspension. Because the elements are generally in an aqueous suspension, the elements can be mixed to form a uniform mixture or suspension, which can include stirring or agitating by hand or using mechanical mixing. As a result of mixing, the protonated compound can be formed within the first mixture.

In a second step, graphene can be mixed with water to form a slurry or suspension. As described above, various forms of graphene can be used to form a stable graphene in water mixture.

In a third step, the wax can be combined with the ceramic compound. In the third step, the wax may be supplied dry or in a water or solvent based solution. When the wax is dry, a fluid such as water, an organic solvent, or the like may be added. In order to form a stable mixture of two or more immiscible liquids in suspension by using small percentages of emulsifier to form a well-mixed emulsion, the wax may be agitated to form an emulsion prior to adding the ceramic component. Generally, agitation is provided at least about 8,000 revolutions per minute (RPM), about 9,000 RPM, or even about 10,000 RPM for at least about 30 minutes. Various forms of mechanical agitation such as ultrasonication, applying a shear stress (e.g., shearing force) such as an emulsifier, using a homogenizer, or a combination thereof. As the wax is agitated, the ceramic component can be added to form a uniform mixture of the wax and ceramic component as an emulsion.

The first mixture comprising the protonated compound can then be mixed with the graphene suspension. In some aspects, the first mixture can be added into the second mixture, and in other embodiments, the second mixture can be added into the first mixture. The mixture forming the base solution can be agitated while the other mixture is added or blended. This agitation can help to form a uniform mixture. While not intending to be limited by theory, it has been found that mixing the graphene with the organosilicone and/or silicone quaternary compounds can result in the graphene and/or silicon compounds to form agglomerates such that one or more of the components may separate from the mixture. The formation of the protonated compounds prior to mixing with the graphene can allow a stable suspension to be created. The resulting mixture can then form a fourth intermediate mixture.

Finally, the emulsion of the wax and ceramic compound can be mixed with the fourth intermediate mixture to form the coating composition as a stable suspension. The fourth mixture may be agitated by being stirred, sheared, or the like during the addition of the third mixture to ensure proper mixing of the emulsion into the final coating composition. As described herein, one or more additional compounds can be provided in the coating composition. The additional components may be combined into the first mixture as part of the overall mixing process. The result of the mixing process is the coating composition as described herein.

In use, the coating composition can be applied to a surface to form a coating layer. Because the coating composition is an aqueous based composition, the coating composition can be applied to a surface that is wetted. The active components can then bond to the surface to form the coating, and the remaining components can be washed away with an aqueous fluid rinse to leave the resulting coating on the surface.

In some aspects, a method of forming a applying a coating to a surface can comprise: wetting the surface with an aqueous solution such as water, while the surface is wetted, applying the coating composition as described herein to the surface, where the coating is formed on the surface based on applying the coating composition to the surface, and rinsing the surface with an aqueous solution after applying the coating. While any remaining water could be allowed to dry, the surface can also be dried such as by using a towel. A buffing step may help to shine the surface after the coating is formed.

A number of components in the coating composition are present to form a stable formulation. When the coating composition is applied to the surface, the coating composition can be hydrophilic, which can allow the coating composition to evenly coat the wetted surface. Moreover, the coating composition may have a positive charge, which facilitates its application to a negatively charged object, such as a vehicle. During the coating process, the various components such as the silicone quaternary compounds, the organosilicone compounds, the wax, the graphene, and the ceramic component can bond to the surface to form a coating layer. The components of the coating layer are generally hydrophobic, and with the rinsing and removal of the hydrophilic compounds (such that they pass away with the rinsing water), the remaining coating layer can be hydrophobic.

The resulting coating layer can be disposed on the surface and comprise the wax, the graphene, and the ceramic compound. The silicone quaternary compounds and the organosilicone compounds can also be present.

The resulting coating can provide for a protective layer on the surface, which can in some aspects serve as a sealant. The coating can provide hydrophobicity, durability, floss, and hardness to the surface. The coating can help to provide stain resistance and removal of surface contaminants that may form on the coating, thereby protecting the surface over time. In one embodiment, the coating may provide about a 20 percent (%) greater contact angle and about a 73% less slide-off angle compared to a current coating composition. Moreover, the coating may provide a stain release improvement of at least about 50% compared to a current coating composition.

Having described various coatings, compositions, and methods, certain aspects can include, but are not limited to:

In a first aspects, a composition for coating a surface comprises an aqueous solution; graphene; a ceramic compound; a wax; and a protonated compound.

A second aspect can include the composition of the first aspect, further comprising a mineral oil.

A third aspect can include the composition of the first or second aspect, wherein the protonated compound comprises a siloxane.

A fourth aspect can include the composition of the third aspect, wherein the siloxane comprises a polydimethylsiloxane.

A fifth aspect can include the composition of any one of the first to fourth aspects, wherein the ceramic compound comprises silicon oxide.

A sixth aspect can include the composition of any one of the first to fifth aspects, wherein the aqueous solution comprises between about 50 wt. % and 95 wt. % of the composition.

A seventh aspect can include the composition of any one of the first to sixth aspects, wherein the graphene comprises between about 0.001 wt. % and about 3 wt. % of the composition.

An eighth aspect can include the composition of any one of the first to seventh aspects, wherein the ceramic compound comprises between about 0.1 wt. % and 3 wt. % of the composition.

A ninth aspect can include the composition of any one of the first to eighth aspects, wherein the wax comprises between about 1 wt. % and about 15 wt. % of the composition.

A tenth aspect can include the composition of any one of the first to ninth aspects, wherein the protonated compound comprises between about 1 wt. % and about 20 wt. % of the composition.

An eleventh aspect can include the composition of any one of the first to tenth aspects, further comprising one or more of: an emulsifier, a surfactant, a thickener, a pH adjusting agent, or any combination thereof.

A twelfth aspect can include the composition of any one of the first to eleventh aspects, wherein the composition is stable and the components do not separate from the composition.

In a thirteenth aspect, a method of forming a coating composition comprises combining water, an organosilicon composition, a silicone quaternary compound, and an acid to form a first solution; providing a second solution comprising graphene in an aqueous fluid; and forming a third solution comprising a wax and a ceramic compound; mixing the first solution with the second solution to form a fourth solution; and mixing the third solution with the fourth solution to form the coating composition.

A fourteenth aspect can include the method of the thirteenth aspect, further comprising: protonating the organosilicon composition with the acid in the first solution prior to combining the first solution with the second solution.

A fifteenth aspect can include the method of the thirteenth or fourteenth aspect, wherein forming the third solution comprises: agitating the wax in a fluid; and while agitating the wax in the fluid, combining the ceramic compound with the wax in the fluid.

A sixteenth aspect can include the method of the thirteenth aspect, wherein agitating the wax in the fluid comprises emulsifying the wax in the fluid prior to combining the ceramic compound.

A seventeenth aspect can include the method of any one of the thirteenth to sixteenth aspects, wherein agitating the wax in the fluid comprises: using a high speed mixer to emulsify the wax in the fluid.

An eighteenth aspect can include the method of any one of the thirteenth to seventeenth aspects, wherein the first solution further comprises a mineral oil.

A nineteenth aspect can include the method of any one of the thirteenth to eighteenth aspects, wherein the organosilicone compound comprises a siloxane.

A twentieth aspect can include the method of the nineteenth aspect, wherein the siloxane comprises a polydimethylsiloxane.

A twenty first aspect can include the method of any one of the thirteenth to twentieth aspects, wherein the ceramic compound comprises silicon oxide.

A twenty second aspect can include the method of any one of the thirteenth to twenty first aspects, wherein the coating composition comprises an aqueous solution at between about 50 wt. % and 95 wt. % of the coating composition.

A twenty third aspect can include the method of any one of the thirteenth to twenty second aspects, wherein the coating composition comprises graphene in an amount of between about 0.001 wt. % and about 3 wt. % of the coating composition.

A twenty fourth aspect can include the method of any one of the thirteenth to twenty third aspects, wherein the coating composition comprises ceramic compound in an amount of between about 0.1 wt. % and 3 wt. % of the coating composition.

A twenty fifth aspect can include the method of any one of the thirteenth to twenty fourth aspects, wherein the coating composition comprises the wax in an amount of between about 1 wt. % and about 15 wt. % of the coating composition.

A twenty sixth aspect can include the method of any one of the thirteenth to twenty fifth aspects, wherein the coating composition comprises the organosilicon composition in an amount of between about 1 wt. % and about 20 wt. % of the composition.

A twenty seventh aspect can include the method of any one of the thirteenth to twenty sixth aspects, wherein the coating composition further comprises one or more of: an emulsifier, a surfactant, a thickener, a pH adjusting agent, or any combination thereof.

In a twenty eighth aspect, a method of applying a coating to a surface comprises: wetting the surface with an aqueous solution; while the surface is wetted, applying the coating composition of any one of the first to twelfth aspects to the surface, wherein the coating is formed on the surface based on applying the coating composition to the surface; and rinsing the surface with an aqueous solution after applying the coating.

A twenty ninth aspect can include the method of the twenty eighth aspect, further comprising: drying the surface after rinsing the surface.

A thirtieth aspect can include the method of the twenty eighth or twenty ninth aspect, wherein the coating composition is hydrophilic when applied to the wetted surface.

A thirty first aspect can include the method of any one of the twenty eighth to thirtieth aspects, wherein the coating is hydrophobic after rinsing the surface.

A thirty second aspect can include the method of any one of the twenty eighth to thirty first aspects, wherein rinsing the surface removes one or more components of the coating composition to leave the coating on the surface.

In a thirty third aspect, a coating layer disposed on a surface comprises a wax; graphene; and a ceramic compound, wherein the graphene and ceramic compound are disposed within the wax as a layer on the surface.

A thirty fourth aspect can include the coating layer of the thirty third aspect, wherein the ceramic compound comprises silicon oxide.

Embodiments are discussed herein with reference to the Figures, if included. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present application or of any further application derived therefrom.

What is claimed is:

1. A composition for coating a surface, the composition comprising:
an aqueous solution;
a carbon allotrope having some carbon atoms having less bonds than quaternary carbon atoms;
a ceramic compound;
a wax; and
a protonated compound.

2. The composition of claim 1, further comprising a mineral oil.

3. The composition of claim 1, wherein the protonated compound comprises a siloxane.

4. The composition of claim 3, wherein the siloxane comprises a polydimethylsiloxane.

5. The composition of claim 1, wherein the ceramic compound comprises a silicon oxide.

6. The composition of claim 1, wherein the aqueous solution comprises between about 50 wt. % and 95 wt. % of the composition.

7. The composition of claim 1, wherein the composition comprises:
between about 0.001 wt. % and about 3 wt. % of the carbon allotrope;
between about 0.1 wt. % and 3 wt. % of the ceramic compound;
between about 1 wt. % and about 15 wt. % of the wax; and
between about 1 wt. % and about 20 wt. % of the protonated compound.

8. The composition of claim 1, further comprising one or more of: an emulsifier, a surfactant, a thickener, a pH adjusting agent, or any combination thereof.

9. The composition of claim 1, wherein the composition is a substantially uniform suspension.

10. The composition of claim 1, wherein the carbon allotrope has some tertiary carbon atoms.

11. The composition of claim 1, wherein the carbon allotrope comprises a graphene.

12. The composition of claim 1, wherein the composition has a cationic charge.

13. A method of forming a coating composition, the method comprising:
combining water, an organosilicon composition, a silicone quaternary compound, and an acid to form a first solution;
providing a second solution comprising a carbon allotrope having some carbon atoms with less bonds than quaternary carbon atoms in an aqueous fluid;
forming a third solution comprising a wax and a ceramic compound;
mixing the first solution with the second solution to form a fourth solution; and
mixing the third solution with the fourth solution to form the coating composition.

14. The method of claim 13, wherein the carbon allotrope comprises tertiary carbon atoms.

15. The method of claim 13, wherein the carbon allotrope comprises a graphene.

16. A method of applying a coating to a surface, the method comprising:
wetting the surface with an aqueous solution;
while the surface is wetted, applying the composition according to claim 1 to the surface, wherein the coating is formed on the surface based on applying the composition to the surface; and
rinsing the surface with an aqueous solution after applying the coating.

17. The method of claim 16, wherein the composition is hydrophilic and cationic when applied to the wetted surface.

18. The method of claim 16, wherein the carbon allotrope of the composition comprises a graphene.

19. A coating layer disposed on a surface, the coating layer comprising:
a wax;
a tertiary carbon allotrope; and
a ceramic compound, wherein the tertiary carbon allotrope and the ceramic compound are disposed within the wax as a layer on the surface.

20. The coating layer of claim 19, wherein the tertiary carbon allotrope comprises a graphene and the ceramic compound comprises a silicon oxide.
